(19) United States
(12) Patent Application Publication
(10) Pub. No.: US 2010/0206595 A1
(43) Pub. Date: Aug. 19, 2010

(54) AUXILIARY HANDLE

(75) Inventor: Hikaru KAMEGAI, Anjo-shi (JP)

Correspondence Address: OLIFF & BERRIDGE, PLC, P.O. BOX 320850, ALEXANDRIA, VA, 22320-4850, US

(73) Assignee: MAKITA CORPORATION

(21) Appl. No.: 12/704,342

(22) Filed: Feb. 11, 2010

(30) Foreign Application Priority Data
Feb. 13, 2009 (JP) 2009-31671

(51) Int. Cl. B25F 5/02; B25G 1/01

(52) U.S. Cl. 173/162.2

(57) ABSTRACT

It is an object of the invention to improve vibration reduction of an auxiliary handle for a hand-held power tool. According to the invention, a representative elongate auxiliary handle 121 to be mounted to a tool body 103 of a power tool 101 includes a handle body 123 that is fixedly mounted to the tool body 103 and an elongate grip 125. The grip 125 has a grip region on its outer surface to be held by a user, and the grip 125 is mounted to the handle body 123 via elastic elements 133 in between a middle region of the grip region in its longitudinal direction and an end of the grip which is remote from the tool body 103.

### BACKGROUND OF THE INVENTION

1. Field of the Invention

The invention relates to a vibration proof auxiliary handle for a hand-held power tool.

2. Description of the Related Art

Japanese laid-open patent publication No. 2004-249430 discloses an auxiliary handle mounted to a body of an electric disc grinder. According to the known auxiliary handle, a grip to be held by a user is connected to a handle body fixedly mounted to the body of the disc grinder via spherical surfaces such that the grip is rotatable in all directions. Vibration-proofing rubbers are disposed between the spherical surfaces of the handle body and the grip to form vibration-proofing elastic elements that exert a spring force against relative rotation of the grip. With such construction, vibration exerted to the grip via the handle body can be reduced by the vibration-proofing rubbers. As a result, user fatigue can be alleviated and the usability can be improved.

On the other hand, it is desired to further improve the vibration proofing effect.

### SUMMARY OF THE INVENTION

It is, accordingly, an object of the invention to improve vibration reduction effect of an auxiliary handle for a hand-held power tool.

The above-described object can be achieved by a claimed invention. An auxiliary handle according to the invention includes a handle body that is fixedly mounted to the tool body and an elongate grip. The grip has a grip region on its outer surface to be held by a user, and the grip is mounted to the handle body via elastic elements in a predetermined region between a middle region of the grip region in its longitudinal direction and an end of the grip which is remote from the tool body.

According to the invention, the grip is mounted to the handle body via elastic elements at a predetermined region between a middle region of the grip region in its longitudinal direction and an end of the grip which is remote from the tool body. End region of the longitudinal region of the grip which is close to the tool body (proximal end region) is located remote from a vibrating source (elastic elements). Therefore, the vibration transmissibility is reduced so that vibration of this end region becomes lower than that of the vibrating source. When the auxiliary handle mounted to a power tool is actually held by a user for operation, the user tends to hold an end region of the auxiliary handle which is close to the tool body. Such tendency is stronger when the power tool is a grinding tool such as a grinder or an impact tool such as a hammer which performs an operation while exerting a pressing force in a direction in which a tool bit is pressed against a workpiece. According to this invention, due to lessened vibration on the proximal end region of the grip which is to be held by the user as described above, user discomfort or fatigue can be alleviated and the usability can be improved.

Preferably, the predetermined region may be a middle region of the grip. In other words, the grip may be mounted to the handle body via the elastic elements in a middle region of the grip region in its longitudinal direction.

Further, as another aspect of the invention, the elastic element may preferably deform in all directions and the deformation may preferably include shearing deformation. According to this invention, vibration is reduced by deformation of the grip with respect to the handle body in all directions. Therefore, it is effective when used for a power tool such as a grinder or a polisher in which the input direction of vibration is not constant. Further, the elastic element may have lower shearing stiffness compared with their compressive stiffness. Therefore, a higher vibration reducing effect can be obtained by shearing deformation than by compressive deformation. Because the deformation includes shearing deformation, the effect of reducing vibration of the grip by the elastic elements can be enhanced.

Preferably, the elastic element may include a plurality of rubber balls and each of the rubber balls may be acted upon by shearing forces. With such construction, the vibration proofing structure having a higher vibration reducing effect can be realized.

As another aspect of the invention, a weight may preferably be provided on at least one of the closest side and the remotest side of the grip with respect to the tool body. By such arrangement of the weight, the natural vibration frequency of the grip is lowered, so that vibration can be alleviated. Therefore, user discomfort or fatigue can be reduced, so that the usability can be further enhanced.

A power tool having any one of the above-described aspects of the auxiliary handle according to the invention may preferably be provided.

Other objects, features and advantages of the present invention will be readily understood after reading the following detailed description together with the accompanying drawings and the claims.

### BRIEF DESCRIPTION OF THE DRAWINGS

FIG. 1 is a perspective view showing an electric disc grinder having a side handle or an auxiliary handle according to a first embodiment of the invention.

FIG. 2 is a front view of the side handle according to the first embodiment.

FIG. 3 is a plan view of the side handle.

FIG. 4 is a sectional view taken along line A-A of FIG. 2.

FIG. 5 is a sectional view taken along line B-B of FIG. 3.

FIG. 6 is a sectional view taken along line C-C of FIG. 2.

FIG. 7 is a sectional view taken along line D-D of FIG. 2.

FIG. 8 is a sectional view taken along line E-E of FIG. 3.

FIG. 9 is a partly cutaway side view showing a hammer drill having a side handle or an auxiliary handle according to a second embodiment of the invention.

FIG. 10 is a front view of the side handle according to the second embodiment.

FIG. 11 is a sectional view taken along line F-F of FIG. 10.

FIG. 12 is a sectional view taken along line G-G of FIG. 11.

### REPRESENTATIVE EMBODIMENT OF THE INVENTION

Each of the additional features and method steps disclosed above and below may be utilized separately or in conjunction with other features and method steps to provide and manufacture improved auxiliary handles and method for using such auxiliary handles and devices utilized therein. Representative examples of the present invention, which examples utilized many of these additional features and method steps in conjunction, will now be described in detail with reference to the drawings. This detailed description is merely intended to teach a person skilled in the art further details for practicing preferred aspects of the present teachings and is not intended to limit the scope of the invention. Only the claims define the scope of the claimed invention. Therefore, combinations of features and steps disclosed within the following detailed description may not be necessary to practice the invention in the broadest sense, and are instead taught merely to particularly describe some representative examples of the invention, which detailed description will now be given with reference to the accompanying drawings.

### First Embodiment

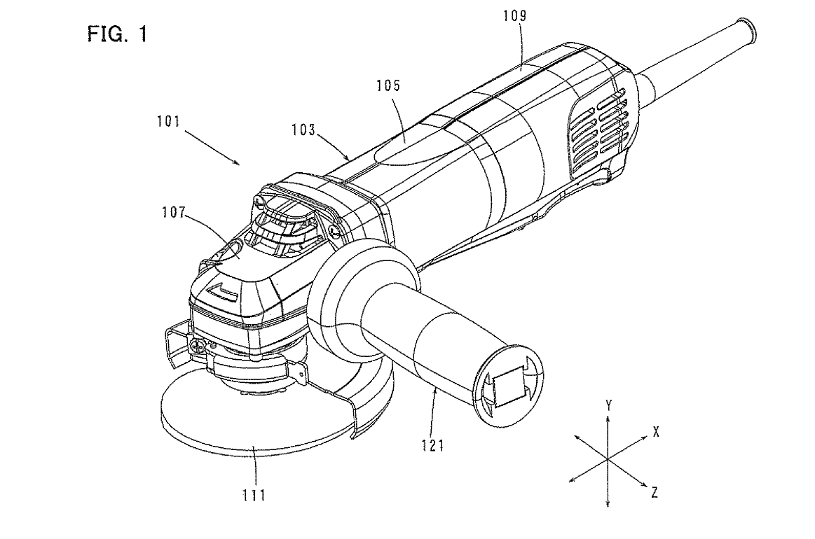

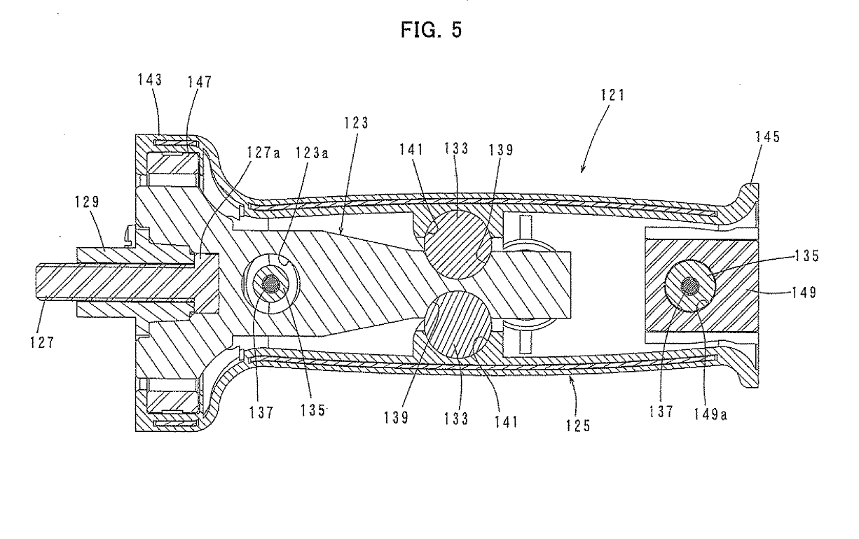

A first embodiment of the invention is now described with reference to FIGS. 1 to 8. In this embodiment, an auxiliary handle is applied to an electric disc grinder as a representative example of a power tool. First, the construction of an electric disc grinder 101 is briefly explained with reference to FIG. 1. The electric disc grinder 101 includes a body 103 that forms an outer shell of the electric disc grinder 101, and a tool bit in the form of a grinding wheel 119 arranged in the tip end region of the body 103. The body 103 mainly includes a motor housing 105, a gear housing 107 connected to one end of the motor housing 105, and a rear cover 109 connected to the other end of the motor housing 105. The body 103 is a feature that corresponds to the “tool body” according to this invention. For the sake of convenience of explanation, the side of a grinding wheel 111 is taken as the front side and the opposite side as the rear side in the longitudinal direction of the body 103.

A driving motor (not shown) is housed in the generally cylindrical motor housing 105. The gear housing 107 is connected to a front end of the motor housing 105 and houses a power transmitting mechanism (not shown) for transmitting the rotating output of the driving motor to the grinding wheel 111. The rotating output of the driving motor is transmitted to the grinding wheel 111 as rotation in the circumferential direction via the power transmitting mechanism. The grinding wheel 111 is arranged on the front portion of the body 103 in the longitudinal direction such that its axis of rotation is perpendicular to the longitudinal direction of the body 103 (to the axis of rotation of the driving motor).

Further, the generally cylindrical rear cover 109 is connected to the rear end (right end as viewed in FIG. 1) of the motor housing 105, and a side handle 121 is detachably mounted on the side of the gear housing 107. The motor housing 105 and the rear cover 109 are arranged such that their longitudinal direction runs in the longitudinal direction of the body 103, while the side handle 121 is mounted such that its longitudinal direction runs transversely to the longitudinal direction of the body 103. A rear region of the motor housing 105 and the rear cover 109 form a grip part (main handle) to be held by a user.

When the user holds the above-described grip part and the side handle 121 and operates a switch knob for actuation of an electric switch which is mounted on the grip part, which is not shown, in order to drive the driving motor, the user can rotationally drive the grinding wheel 111 via the power transmitting mechanism and appropriately perform a grinding or polishing operation or a cutting operation on a workpiece.

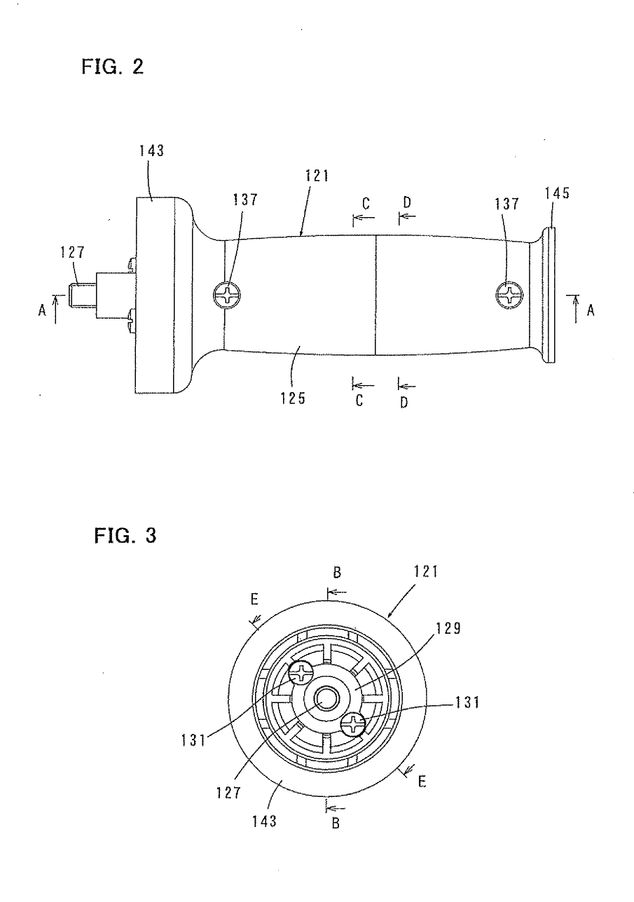

Now, the side handle 121 according to this embodiment is described with reference to FIGS. 2 to 8. The side handle 121 is an elongate member extending generally in parallel to a direction transverse to the longitudinal direction of the body 103. The side handle 121 mainly includes a handle body 123 which is detachably mounted to a handle mounting portion formed on the side of the gear housing 107, and a grip 125 to be held by the user. The handle body 123 and the grip 125 are features that correspond to the “handle body” and the “grip”, respectively, according to this invention. The handle mounting portion is formed by a mounting screw hole (not shown) of which axis extends in a direction perpendicular to the longitudinal direction of the body 103.

The handle body 123 is a generally columnar rod-like member having a mounting screw 127 on one end (left end as viewed in FIG. 2) in its longitudinal direction. The handle body 123 is detachably mounted to the gear housing 107 by the mounting screw 127 into the mounting screw hole of the gear housing 107. As shown in FIG. 8, the mounting screw 127 is inserted into a recess formed in one end of the handle body 123, and in this state, a head 127a of the mounting screw 127 is pressed and locked by a generally cylindrical covering member 129. The covering member 129 is fixedly connected to the handle body 123 via an ear-like projection protruding from the outer surface of the covering member 129 by screws 131. Therefore, if the mounting screw 127 is damaged, the covering member 129 can be removed for replacement of the mounting screw 127. For the sake of convenience of explanation, the mounting screw 127 side in the longitudinal direction of the side handle 121 (the mounting side with respect to the body 103) is referred to as a proximal end and the opposite side as a distal end.

The grip 125 is longer than the handle body 123. The grip 125 has both ends open in its longitudinal direction. Further, the grip 125 is a generally spindle-shaped (generally cylindrical) hollow member having a bulged outer surface in the middle in the longitudinal direction. The handle body 123 is inserted into the grip 125 and generally coaxially arranged. The grip 125 is connected to the distal end of the handle body 123 generally at the middle of the grip 125 via a plurality of vibration proofing spherical elastic rubbers 133. A predetermined clearance is provided between the outer circumferential surface of the handle body 123 and the inner circumferential surface of the grip 125, so that the handle body 123 is spaced apart from the grip 125 in regions other than the region of the elastic rubbers 133. The elastic rubber 133 is a feature that corresponds to the “elastic element” according to this invention.

The grip 125 is formed by two halves 125A, 125B which are joined together at mating surfaces in the longitudinal direction. A cylindrical protrusion 135 is formed on the mating surface side of each of the two halves 125A, 125B, and the two halves 125A, 125B are joined together by fastening the protrusions 135 together by a screw 137. Two pairs of cylindrical protrusions 135 are provided on the grip 125 with a predetermined spacing in the longitudinal direction. One pair of the cylindrical protrusions 135 is loosely inserted through a through hole 123a which radially extends through a generally middle portion of the handle body 123 in the longitudinal direction. This protrusion pair 135 is held in non-contact with the handle body 123.

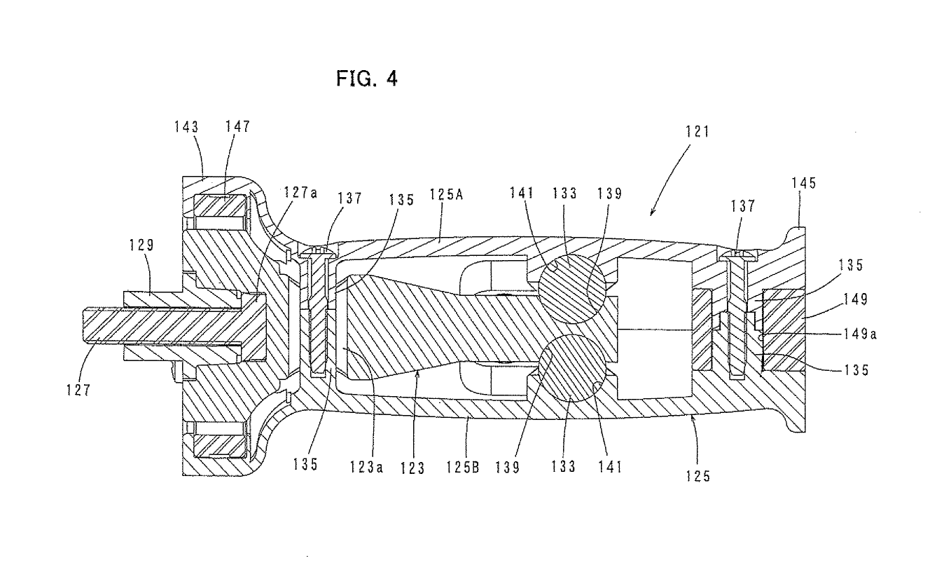

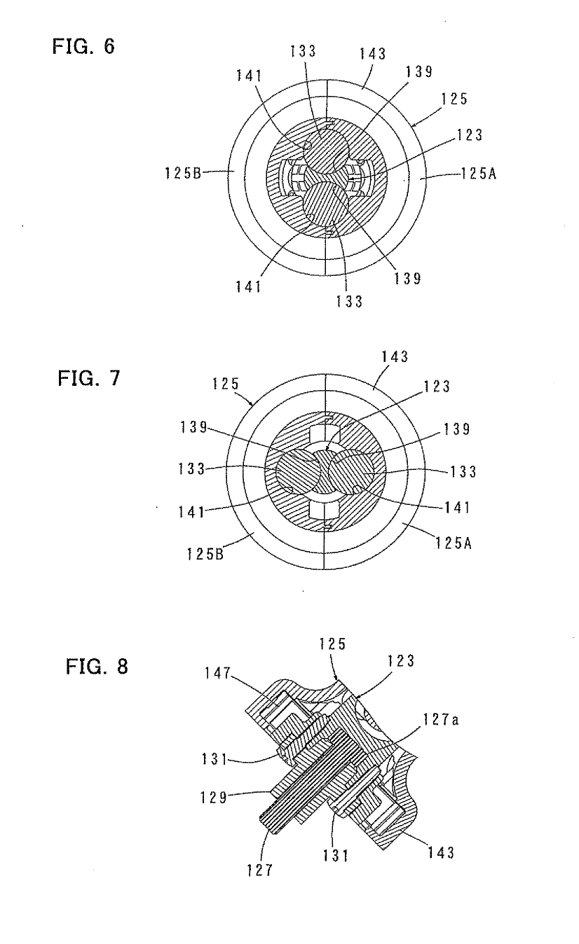

As shown in FIGS. 4 to 7, the elastic rubbers 133 are arranged in two-stage configuration, and two elastic rubbers are oppositely disposed with a 180-degree spacing in the circumferential direction in each stage. The elastic rubbers of a first stage are located closer to the distal end of the handle body 123 than those of a second stage and arranged to be staggered 90 degrees in the circumferential direction apart from those of the second stage. Specifically, four elastic rubbers 143 are provided in total. Taking the longitudinal direction of the grip 125 (the longitudinal direction of the handle) as a z-axis, the vertical direction transverse to the z-axis as a y-axis and the horizontal direction transverse to the z-axis (the longitudinal direction of the disc grinder) as an x-axis in FIG. 1, two of the elastic rubbers 143 are arranged in the direction of the x-axis in the first stage (see FIG. 7), and the other two are arranged in the direction of the y-axis in the second stage (see FIG. 6).

Generally semispherical body-side recesses 139 are formed as supports for individually supporting the elastic rubbers 133 in the outer surface of a distal end portion of the handle body 123. Correspondingly, generally semispherical grip-side recesses 141 are formed as supports for individually supporting the elastic rubbers 133 in the inner surface of a generally middle portion of the grip 125 in its longitudinal direction. The both recesses 139, 141 support the spherical elastic rubbers 133. In this manner, the grip 125 is mounted to the handle body 123 in a floatingly supported state (in a noncontact state) via the elastic rubbers 133 generally at the middle of the grip 125 in its longitudinal direction. As a result, the grip 125 is allowed to move with respect to the handle body 123 in all directions including the z-, y- and x-axes and the circumferential direction around the z-axis by deformation of the elastic rubbers 133.

The outer surface of the grip 125 is designed as a grip region to be held by the user's hand. In the grip region, collars 143, 145 are provided in a proximal end region and a distal end region, respectively, and overhang radially outward. The proximal and distal end collars 143, 145 serve as slip stoppers for the user's fingers.

Further, weights 147, 149 for vibration reduction are arranged in the proximal and distal ends of the grip 125 in the longitudinal direction. The proximal end weight 147 located close to the mounting screw 127 of the handle body 123 has a generally ring-like shape and is surrounded and supported by the proximal end collar 143 such that it is not visible from the outside. The distal end weight 149 located remote from the mounting screw 127 has a generally rectangular block-like shape and is held and locked between the two halves 125A, 125B in a bore opening of the grip 125 when the two halves 125A, 125B are joined together.

The distal end weight 149 has a through hole 149a extending in a direction transverse to the longitudinal direction, and the cylindrical protrusions 135 of the halves 125A, 125B are inserted into the through hole 149a. Thus, the distal end weight 149 is held between the two halves 125A, 125B and prevented from moving in a direction transverse to the holding direction by the cylindrical protrusions 135, so that the weight 149 is securely supported within the grip 125. Further, the distal end weight 149 also serves as a cap for closing the opening of the grip 125.

The proximal end of the handle body 123 on the mounting screw 127 side overhangs radially outward and its outer circumferential surface faces the inner circumferential surface of the proximal end weight 147 with a predetermined clearance therebetween. Preferably, a clearance between the outer surface of the handle body 123 and the inner surface of the grip 125 including the weights 147, 149 is minimized, while the relative movement of the handle body 123 and the grip 125 which is necessary for vibration proofing is allowed. As a result, entry of dust into the internal space of the grip through the clearance can be prevented.

In the side handle 121 having the above-described construction, when a grinding operation is performed while the grip part of the disc grinder 101 and the side handle 121 are held, vibration caused in the body 103 is reduced by the elastic rubbers 133 when the vibration is transmitted to the grip 125 via the handle body 123 of the side handle 121.

In this case, in this embodiment, the grip 125 is mounted to the handle body 123 via the elastic rubbers 133 generally at the middle in the longitudinal direction. With this construction, in the longitudinal region of the grip 125, the proximal end region close to the body 103 of the disc grinder 101 and the distal end region remote from the body 103 are located remote from the source of vibration (the elastic rubbers 133). Therefore, the vibration transmissibility is reduced, so that vibration of these end regions becomes lower than that of the vibrating source.

In the disc grinder 101, in order to prevent slip of user's fingers or to press the grinding wheel 111 on a workpiece, generally, the user holds the grip 125 with the thumb, index finger and web part between the thumb and the index finger pressed on the proximal end collar 143. When the grip 125 is held in this manner, like in this embodiment, due to lessened vibration on the proximal end region of the grip 125 which is to be held by the user, user discomfort or fatigue is reduced, compared with a construction, for example, in which the grip 125 is connected to the handle body 123 at the proximal end. Thus, the usability is improved.

Further, the grip 125 is movable with respect to the handle body 123 in all directions including the z-, y- and x-axes and the circumferential direction around the z-axis by deformation of the elastic rubbers 133. With this construction, vibration of the grip 125 can be reduced in all directions. This is particularly effective in the disc grinder 101 in which the input direction of vibration is not constant.

Further, in the longitudinal direction of the side handle 121 (the direction of the z-axis) and the circumferential direction around the longitudinal direction, all of the elastic rubbers 133 are acted upon by forces in a shearing direction. The shearing direction refers to a direction in which the elastic rubbers 133 are linearly cut or twisted off. Therefore, the elastic rubbers 133 have lower shearing stiffness compared with their compressive stiffness, so that a higher vibration reducing effect can be obtained by shearing deformation than by compressive deformation. Thus, according to this embodiment, by utilizing this property, the vibration reducing effect in the longitudinal direction and the circumferential direction of the grip 125 can be further enhanced. Further, vibration in the vertical and horizontal directions (along the y- and x-axes) transverse to the longitudinal direction is reduced by compressive deformation of two of the four elastic rubbers 133 and shearing deformation of the other two elastic rubbers 133.

Further, in this embodiment, the elastic rubbers 133 are spherical and the body side recesses 139 and the grip side recesses 141 support the elastic rubbers 133. With this construction, the elastic rubbers 133 can be securely supported. Moreover, the elastic rubbers 133 are arranged in two-stage configuration in the longitudinal direction, and the elastic rubbers of the first stage are arranged to be staggered 90 degrees in the circumferential direction apart from those of the second stage. Thus, the grip 125 is securely supported without wobbling with respect to the handle body 123.

Further, according to this embodiment, the weights 147, 149 are provided in the proximal and distal ends of the grip 125 in the longitudinal direction. With this construction, the natural vibration frequency of the grip 125 is lowered, so that vibration can be alleviated. Therefore, user discomfort or fatigue can be reduced, so that the usability can be further enhanced.

### Second Embodiment

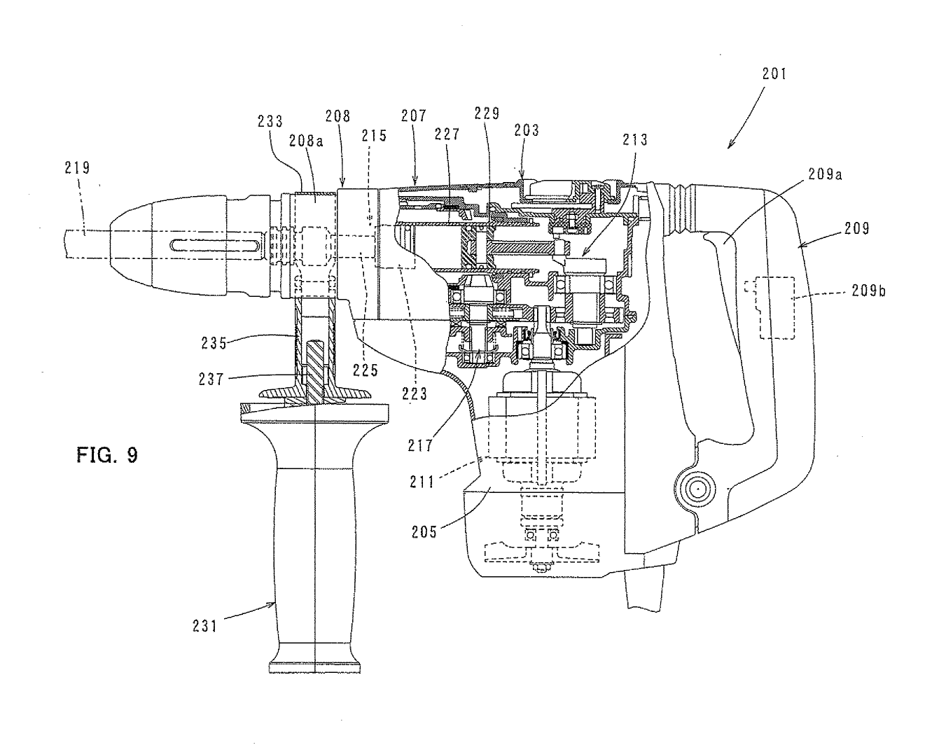

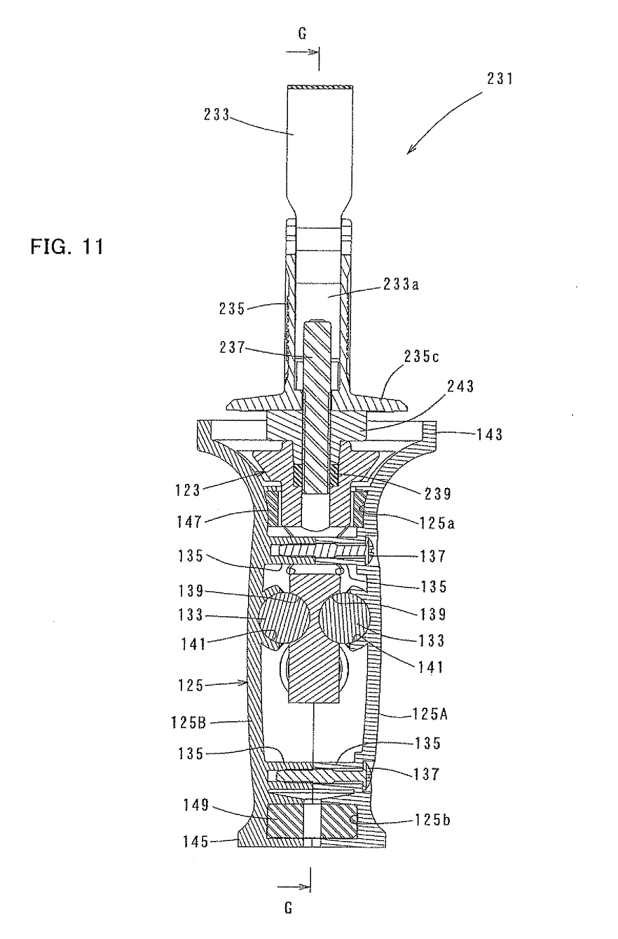

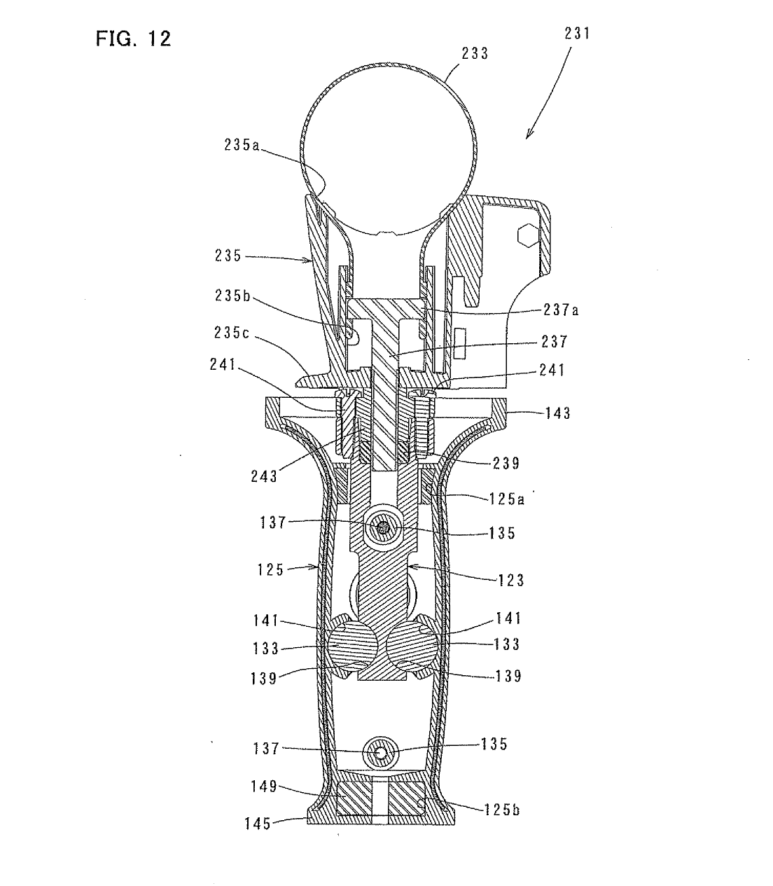

Now, a second embodiment of the invention is described with reference to FIGS. 9 to 12. This embodiment is a variant in which an auxiliary handle is applied to an electric hammer drill as a representative example of a power tool. First, the construction of a hammer drill 201 is briefly explained with reference to FIG. 9. The hammer drill 201 includes a body 203 that forms an outer shell of the hammer drill 201, a tool holder (not shown) connected to a tip end region (on the left as viewed in FIG. 9) of the body 203 in the longitudinal direction, and a tool bit in the form of a hammer bit 219 detachably mounted to the tool holder, and a main handle 209 connected to the other end (right end as viewed in FIG. 9) of the body 203 in the longitudinal direction and designed to be held by a user. The body 203 is a feature that corresponds to the “tool body” according to the invention. The hammer bit 219 is held by the tool holder such that it is allowed to reciprocate with respect to the tool holder in its axial direction (the longitudinal direction of the body 203) and prevented from rotating with respect to the tool holder in its circumferential direction. In the present embodiment, for the sake of convenience of explanation, the side of the hammer bit 219 is taken as the front and the side of the main handle 209 as the rear.

The body 203 mainly includes a motor housing 205 that houses a driving motor 211, a gear housing 207 that houses a motion converting mechanism 213 and a power transmitting mechanism 217, and a cylindrical barrel 208 that houses a striking mechanism 215. The barrel 208 extends in front of the gear housing 207, and an auxiliary handle in the form of a side handle 231 is detachably mounted onto the barrel 208. A trigger 209a and an electric switch 209b are provided on the main handle 209, and when the trigger 209a is depressed by the user, the electric switch 209b is turned on and the driving motor 211 is driven.

The rotating output of the driving motor 211 is appropriately converted into linear motion via the motion converting mechanism 213 and transmitted to the striking mechanism 215. Then, an impact force is generated in the axial direction of the hammer bit 219 via the striking mechanism 215.

The motion converting mechanism 213 which serves to convert rotation of the driving motor 211 to linear motion and transmit it to the striking mechanism 215, mainly includes a crank mechanism. The crank mechanism is designed such that, when the crank mechanism is rotationally driven by the driving motor 211, a driving element in the form of a piston 229 forming a final movable member of the crank mechanism linearly moves in the axial direction of the hammer bit within a cylinder 227.

The striking mechanism 115 mainly includes a striking element in the form of a striker 223 that is slidably disposed within a bore of the cylinder 227 together with the piston 229, and an impact bolt 225 that is disposed in front of the striker 223 and can slide within the tool holder. The striker 223 is driven via an air spring action (pressure fluctuations) of an air chamber of the cylinder 227 which is caused by sliding movement of the piston 229, and then the striker 223 collides with (strikes) the impact bolt 225 and transmits the striking force to the hammer bit 219 via the impact bolt 225.

Further, the rotating output of the driving motor 211 is appropriately converted by the power transmitting mechanism 217 which is mainly formed by a plurality of gears, and then transmitted to the hammer bit 219 via the tool holder. As a result, the hammer bit 219 is rotated in the circumferential direction together with the tool holder.

In the hammer drill 201 constructed as described above, when the user holds the main handle 209 and the side handle 231 by hand and depresses the trigger 209a to turn on the electric switch 209b and drive the driving motor 211, the hammer bit 219 is caused to perform a linear hammering movement in the axial direction and a drilling movement around its axis. Thus, the user can perform chipping, drilling or other similar operation on the workpiece.

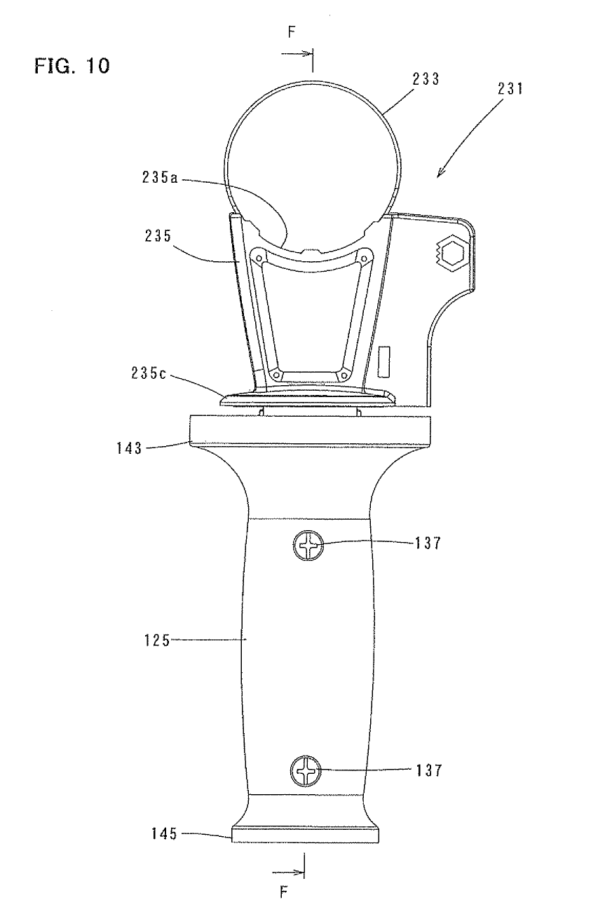

Next, the side handle 231 according to this embodiment is described with reference to FIGS. 10 to 12. The side handle 231 is detachably mounted to the barrel 208 of the hammer drill 201, but in the other points, the side handle 231 has substantially the same construction as the side handle 121 of the first embodiment. Therefore, components or elements in the second embodiment which are substantially identical to those in the first embodiment are given like numerals as in the first embodiment and will not be described or will be only briefly described.

A handle mounting portion 208a is formed on the barrel 208 by a circumferential surface having a predetermined width and extending parallel to the longitudinal direction of the body 203. The side handle 231 is mounted to the handle mounting portion 208a such that the direction of its length is transverse to the longitudinal direction of the barrel 208 (the axial direction of the hammer bit 219).

In order to detachably mount the handle body 123 to the handle mounting portion 208a, the side handle 231 includes a tightening band 233 which is formed by a thin band plate curved into a circular form, a barrel receiver 235 having an engagement surface 235a for receiving the circumferential surface of the barrel 208, and a screw member 237 for band control and a nut 239. These members are provided as components for handle mounting to replace the mounting screw 127 of the first embodiment.

Ends (legs) of the tightening band 233 are inserted into the barrel receiver 235 and slidably mounted in a band guide groove 235b formed in the barrel receiver 235. The nut 239 is fitted into a recess formed in the proximal end of the handle body 123, and in this state, the nut 239 is pressed in the longitudinal direction by a generally cylindrical covering member 243 which is fixed to the handle body 123 by screws 241, so that the nut 239 is fixed to the handle body 123. The barrel receiver 235 has a base 235c on the other end on the side opposite to the engagement surface 235a. The base 235c is held in contact with the covering member 243. The screw member 237 for band control is loosely inserted through the base 235c of the barrel receiver 235 and the covering member 243 and extends in the longitudinal direction of the handle, and one end of the screw member 237 is threadably engaged through the nut 239. A projection 237a is formed on the other end of the screw member 237 and protrudes in a direction transverse to the longitudinal direction. The projection 237a is engaged in engagement holes of both ends 233a of the tightening band 233. Thus, the screw member 237 is connected to the ends 233a of the tightening band 233.

In order to mount the side handle 231 to the handle mounting portion 208a of the barrel 208, first, the body 203 of the hammer drill 201 is inserted from its front end (the hammer bit 219 side) into a circular part defined by the engagement surface 235a of the barrel receiver 235 and the tightening band 233, and this circular part is positioned on the handle mounting portion 208a of the barrel 208. In this state, when the user holds the grip 125 and turns it in one direction, the nut 239 and the handle body 123 connected to the grip 125 via the elastic rubbers 133 are rotated together with the grip 125. As a result, the tightening band 233 is moved toward the engagement surface 235a of the barrel receiver 235 via the screw member 237 that rotates relative to the nut 239. Thus, the handle mounting portion 208a is securely held between the engagement surface 235a and the tightening band 233. In this manner, as shown in FIG. 9, the side handle 231 is mounted to the barrel 208. In FIG. 9, the side handle 231 is shown mounted to extend downward from the barrel 208, but the mounting direction can be arbitrarily changed.

During operation by the hammer drill 201, in order to support the weight of the hammer drill 201, generally, the user holds the grip 125 of the side handle 231 with the thumb, index finger and web part between the thumb and the index finger pressed on the proximal end collar 143. Further, in an operation mode such as hammer drill mode or drill mode in which the hammer bit 219 is driven to rotate in the circumferential direction, some operation may be performed with the hammer drill 201 held in a position rotated 90 degrees on the axis of the hammer bit 219 from the normal position shown in FIG. 9. In this case, the user supports the weight of the hammer drill 201 by holding the grip 125 of the laterally extending side handle 231 (underhand) with the thumb, index finger and web part between the thumb and the index finger pressed on the distal end collar 145 on the side opposite to the proximal end of the grip.

In the side handle 231 according to this embodiment, like in the side handle 121 of the first embodiment, the grip 125 is mounted to the handle body 123 via the elastic rubbers 133 generally at the middle of the grip 125 in its longitudinal direction. With this construction, in the longitudinal region of the grip 125, the proximal end region and the distal end region are located remote from the source of vibration (the elastic rubbers 133). Therefore, the vibration transmissibility is reduced, so that vibration of these end regions becomes lower than that of the vibrating source. Therefore, with the side handle 231 according to this embodiment, when the proximal end or the distal end of the grip 125 is held, user discomfort or fatigue can be reduced, so that the usability is improved.

Further, as for the grip 125, the same effects can be obtained as in the first embodiment in the points that vibration can be reduced in all directions, that a vibration reducing effect can be obtained by utilizing the shearing deformation of the elastic rubbers 133, and that a vibration alleviating effect can be obtained by the weights 147, 149.

In this embodiment, the manner of supporting the weights 147, 149 is slightly different from the first embodiment. The proximal end weight 147 is received in a recess 125a located toward the middle of the grip 125 apart from the proximal end collar 143. The distal end weight 149 is received in a recess 125b formed in the distal end of the grip 125. Therefore, the weights 147, 149 can be easily received in the recesses 125a, 125b when the grip 125 is mounted to the handle body 123 by joining the two halves 125A, 125B together.

Further, the invention is not limited to the above-described embodiments, but may be appropriately modified or changed. Although, in the above embodiments, the grip 125 is connected to the handle body 123 via the elastic rubbers 133 generally at the middle of the grip 125 in its longitudinal direction, the grip 125 may be connected to the handle body 123 at the distal end region remote from the body 103 or 203 (the end on the side opposite to the proximal end). By such connection, the vibration proofing effect in the end region of the grip 125 can be improved.

Further, the shape of the elastic rubbers 133 is not limited to a spherical shape, but it may be a cylindrical shape or a rectangular block-like shape. In this case, the recesses 139, 141 which are formed in the handle body 123 and the grip 125 to support the elastic rubbers 133 are shaped to conform to the outside shape of the elastic rubbers 133.

Further, the weight 147, 149 may be provided only on one of the end regions of the grip 125.

Further, although, in the above embodiments, the side handles 121, 231 are described as being applied to the electric disc grinder 101 and the hammer drill 201, respectively, applicable power tools are not limited to them, but may include any hand-held power tool in which vibration is caused in the tool body during operation.

Having regard to the above-described, following technical aspect can be provided in accordance with the invention.

“The handle body comprises a rod-like member and the grip comprises a cylindrical member. The handle body is inserted from one end of the grip to a middle region of a bore of the grip or the other end of the grip, and the grip is connected to the inserted end of the handle body via the elastic elements.”

“The grip comprises two halves each having a mating surface in the longitudinal direction and is formed by joining the mating surfaces.”

“The elastic rubbers are arranged in two-stage configuration in the longitudinal direction of the handle.”

“The elastic rubbers are received and supported by a handle side recess formed in the handle body and a grip side recess formed in the grip.”

“The two halves hold and lock the weight therebetween when joined together.”

### DESCRIPTION OF NUMERALS

101 electric disc grinder (power tool)
103 body (tool body)
105 motor housing
107 gear housing
109 rear cover
111 grinding wheel (tool bit)
121 side handle (auxiliary handle)
123 handle body
123a through hole
125 grip
125A, 125B half (grip component)
125a, 125b recess
127 mounting screw
127a head
129 covering member
131 screw
133 elastic rubber (elastic element)
135 cylindrical protrusion
137 screw
139 body side recess
141 grip side recess
143 proximal end collar
145 distal end collar
147 proximal end weight
149 distal end weight
149a through hole
201 hammer drill (power tool)
203 body (tool body)
205 motor housing
207 gear housing
208 barrel
208a handle mounting portion
209 main handle
209a trigger
209b electric switch
211 driving motor
213 motion converting mechanism
215 striking mechanism
217 power transmitting mechanism
219 hammer bit (tool bit)
223 striker
225 impact bolt
227 cylinder
229 piston
231 side handle (auxiliary handle)
233 tightening band
233a end
235 barrel receiver
235a engagement surface
235b band guide groove
235c base
237 screw member for band control
237a projection
239 nut
241 screw
243 covering member

1. An elongate auxiliary handle mounted to a tool body of a power tool comprising:
a handle body that is fixedly mounted to the tool body,
an elongate grip,
a grip region provided on an outer surface of the grip, the grip region is held by a user and
an elastic element that connects the handle body and the grip,
wherein the grip is mounted to the handle body via the elastic element at a predetermined region between a middle region of the grip region in the longitudinal direction and an end of the grip which is remote from the tool body.

2. The auxiliary handle according to claim 1, wherein the predetermined region to mount the grip to the handle body is defined by a middle region of the grip region in the longitudinal direction.

3. The auxiliary handle according to claim 1, wherein the elastic element is deformably provided in all directions and the deformation of the elastic element is defined as shearing deformation.

4. The auxiliary handle according to claim 1, wherein the elastic element includes a plurality of rubber balls and each of the rubber balls receives the shearing force.

5. The auxiliary handle according to claim 1 further comprising a weight, wherein the weight is provided on at least one of the closest side and the remotest side of the grip with respect to the tool body.

6. The auxiliary handle according to claim 1, wherein the handle body includes a rod-like member and the grip includes a cylindrical member, the handle body is inserted from one end of the grip to a middle region of a bore of the grip or the other end of the grip, and the grip is connected to the inserted end of the handle body via the elastic elements.

7. The auxiliary handle according to claim 1, wherein the grip includes two halves each having a mating surface in the longitudinal direction and is formed by joining the mating surfaces.

8. The auxiliary handle according to claim 7, wherein the two halves hold and lock the weight between halves when joined together.

9. The auxiliary handle according to claim 1, wherein the elastic element includes elastic rubbers which are arranged in two-stage configuration with respect to the longitudinal direction of the handle.

10. The auxiliary handle according to claim 9, wherein elastic rubbers are received and supported by a handle side recess formed in the handle body and a grip side recess formed in the grip.

11. A power tool having the auxiliary handle according to claim 1.

12. A power tool having the auxiliary handle according to claim 2.

13. A power tool having the auxiliary handle according to claim 3.

14. A power tool having the auxiliary handle according to claim 4.

15. A power tool having the auxiliary handle according to claim 5.

16. A power tool having the auxiliary handle according to claim 6.

17. A power tool having the auxiliary handle according to claim 7.

18. A power tool having the auxiliary handle according to claim 8.

19. A power tool having the auxiliary handle according to claim 9.

20. A power tool having the auxiliary handle according to claim 10.
